(19) United States
(12) Patent Application Publication
(10) Pub. No.: US 2025/0104364 A1
(43) Pub. Date: Mar. 27, 2025

(54) METHOD AND COMPUTING DEVICE FOR DISPLAYING VIRTUAL IMAGE TO USER

(71) Applicants: Tsung-Hsiu YU, Tainan City (TW); Chun-Ching WANG, Tainan City (TW); Shih-Wei CHEN, Kaohsiung City (TW)

(72) Inventors: Tsung-Hsiu YU, Tainan City (TW); Chun-Ching WANG, Tainan City (TW); Shih-Wei CHEN, Kaohsiung City (TW)

(21) Appl. No.: 18/767,023

(22) Filed: Jul. 9, 2024

(30) Foreign Application Priority Data
Sep. 23, 2023 (TW) 112136490

(51) Int. Cl. G06T 19/00; G02B 27/01

(52) U.S. Cl. CPC G06T 19/006; G02B 27/0172

(57) ABSTRACT

A method for displaying a virtual image to a user is implemented by a computing device. The method includes to first obtain an initial position of the user, and define a reference point at the initial position of the user. Then, the computing device obtains a user position of the user, and determines whether a distance between a position of the reference point and the user position is greater than a threshold. If the distance is greater than the threshold, the computing device moves the position of the reference point to a reference position that is at most the threshold away from the user position. Finally, the computing device obtains a display position as a relative position based on the position of the reference point, and displays the virtual image at the display position.

### CROSS-REFERENCE TO RELATED APPLICATION

This application claims priority to Taiwanese Invention patent application Ser. No. 11/213,6490, filed on Sep. 23, 2023, the entire disclosure of which is incorporated by reference herein.

### FIELD

The disclosure relates to a method and a computing device for displaying a

virtual image, and more particularly to a method and a computing device for displaying a virtual image to a user.

### BACKGROUND

In augmented reality (AR) and mixed reality (MR) technologies, when a virtual image is required to be displayed in a field of view of a user, a real-world coordinate system based on real-world space or a display coordinate system based on a head-mounted display are usually required as a coordinate reference for a position where an image is to be displayed.

However, in practice, the user may be moving constantly, and if the virtual image is fixed at a position in the real-world space, the virtual image does not move with the user, thereby making it inconvenient to view. Therefore, it is not appropriate to use the real-world coordinate system as the coordinate reference for the virtual image when the user is moving. Alternatively, if the virtual image is fixed at a position in the display coordinate system and the position is not in front of the user, when the user tries to view the virtual image directly by turning his or her head, the head-mounted display is also turned with the user's head, such that the virtual image along with the position fixed in the display coordinate system is moved further away from where the user was trying to look at.

### SUMMARY

Therefore, an object of the disclosure is to provide a method for displaying a virtual image to a user that can alleviate at least one of the drawbacks of the prior art.

According to the disclosure, a method for displaying a virtual image to a user is implemented by a computing device. The method includes: obtaining an initial position of the user; defining a reference point at the initial position of the user; obtaining a user position of the user; determining whether a distance between a position of the reference point and the user position is greater than a threshold; in response to determining that the distance is greater than the threshold, moving the position of the reference point to a reference position that is at most the threshold away from the user position; and obtaining a display position as a relative position based on the position of the reference point and a display orientation for orienting the virtual image to face the user position, and displaying the virtual image at the display position with the display orientation.

According to the disclosure, a computing device for displaying a virtual image to a user includes a positioning module, a display, and a processor. The positioning module is configured to obtain a position of the user. The processor is configured to obtain an initial position of the user from the positioning module, define a reference point at the initial position of the user, obtain a user position of the user from the positioning module, and determine whether a distance between a position of the reference point and the user position is greater than a threshold. The processor is further configured to, in response to determining that the distance is greater than the threshold, move the position of the reference point to a reference position that is at most the threshold away from the user position. The processor is further configured to obtain a display position as a relative position based on the position of the reference point for orienting the virtual image, and control the display to display the virtual image at the display position with the display orientation.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a computing device according to an embodiment of the disclosure.

FIG. 2 is a flow chart illustrating a method for displaying a virtual image to a user according to an embodiment of the disclosure.

FIG. 3 is a schematic diagram illustrating a real-world coordinate system (denoted as “R”) and a user coordinate system (denoted as “P”) when implementing the method.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

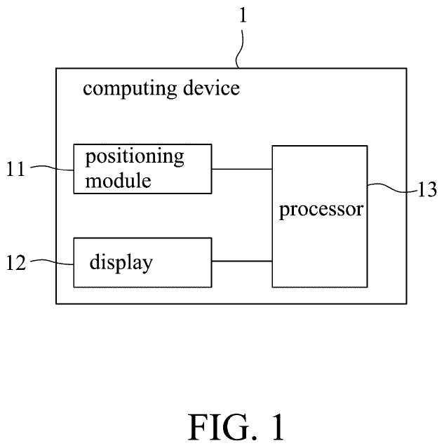

Referring to FIG. 1, according to an embodiment of the disclosure, a method for displaying a virtual image to a user is implemented by a computing device 1 that is held by the user. The computing device 1 includes a positioning module 11, a display 12, and a processor 13 that is electrically connected to the positioning module 11 and the display 12. The computing device 1 may be implemented as a pair of augmented reality (AR) glasses, a combination of a smartphone and a pair of AR glasses, or a combination of a tablet and a pair of AR glasses, but the disclosure is not limited to such. The virtual image may be, but is not limited to, a graphical user interface. The positioning module 11 is configured to obtain a position of the user, may use simultaneous localization and mapping (SLAM) technology to obtain the position of the user at a frequency of, for example, 60 times per second, and may include a gyroscope (not shown), a lidar (not shown), a camera (not shown), and an accelerometer (not shown) when using the SLAM technology. The processor 13 may be, but is not limited to, a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), and/or a system on a chip (SoC), etc.

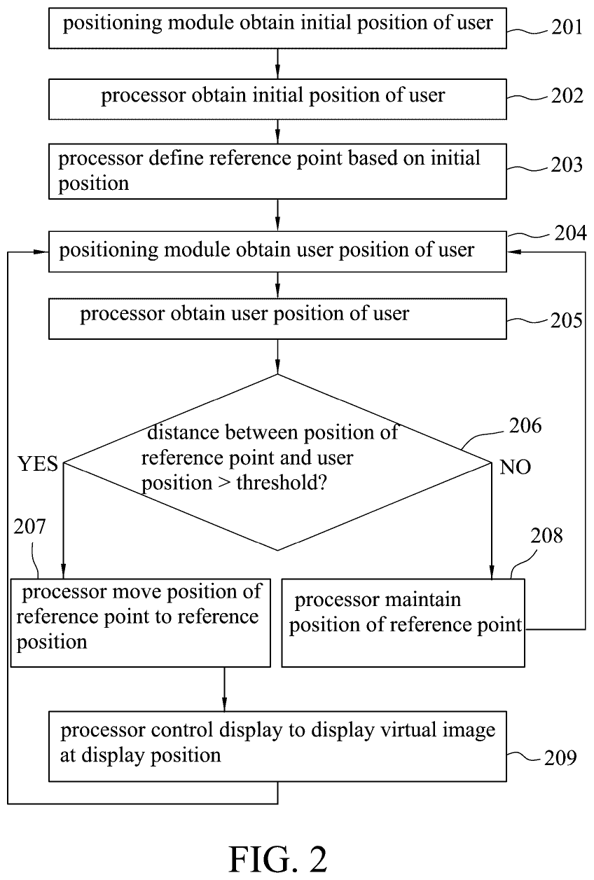

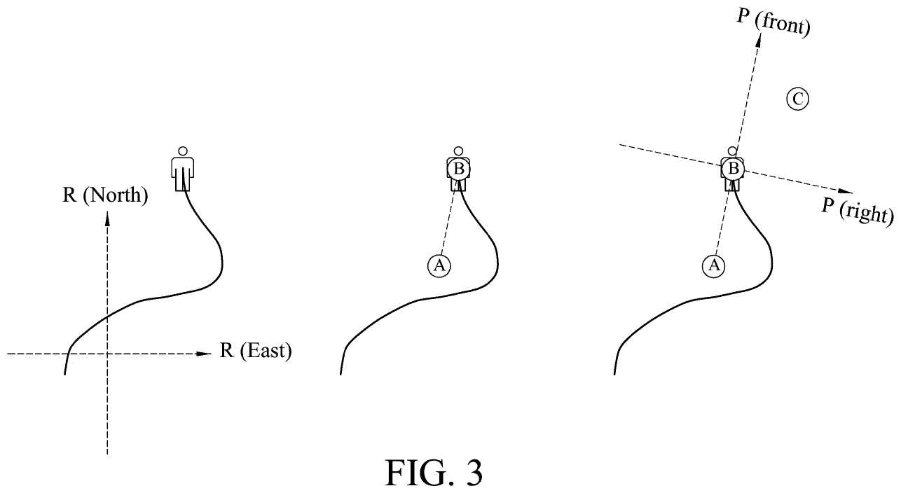

Referring further to FIGS. 2 and 3, a flow of the method includes steps 201 to 209. It should be noted that, the method uses a real-world coordinate system (denoted as “R” in FIG. 3) (i.e., geographical coordinate system) and a user coordinate system (denoted as “P” in FIG. 3), which will be described in further detail in the following.

In step 201, the positioning module 11 obtains an initial position of the user in the real-world coordinate system, and transmits the initial position to the processor 13. In this embodiment, when the computing device 1 implements the method, the computing device 1 is carried by the user, and thus a position of the computing device 1 in the real-world coordinate 10 system is considered as the position of the user. The initial position may be obtained by the positioning module 11 as, for example, a location where the computing device 1 is powered on by the user, or a location where an application corresponding to the method is turned on by the user (i.e., a location of the smartphone or the tablet). At this time, the position of the user is at the initial position.

In step 202, the processor 13 obtains the initial position of the user from the positioning module 11. In step 203, the processor 13 defines a reference point based on the initial position of the user. Specifically, the processor 13 defines the reference point at a temporary position that is far away from the initial position of the user (e.g., by 1 kilometer) and that is in a direction opposite to an orientation of the user in the real-world coordinate system. That is to say, the temporary position is opposite to where the user is facing. At this time, a position of the reference point is at the temporary position, which is behind where the user (i.e., the computing device 1) is facing.

In step 204, the positioning module 11 obtains a user position of the user in the real-world coordinate system (labelled as “B” in FIG. 3), and transmits the user position to the processor 13. At this time, the position of the user is at the user position. It should be noted that, if the user had moved after the initial position of the user was obtained in step 202, then the user position of the user would be different from the initial position; otherwise, the user position is identical to the initial position.

In step 205, the processor 13 obtains the user position of the user from the positioning module 11.

In step 206, the processor 13 determines whether a distance between the position of the reference point and the user position in the real-world coordinate system is greater than a threshold (e.g., 1 to 300 meters). When the processor 13 determines that the distance is greater than the threshold, the flow proceeds to step 207; otherwise, the flow proceeds to step 208. In a case where the user is walking, the threshold may be set to, for example, 3 meters. In a case where the user is riding a high speed vehicle (e.g., a train or a rollercoaster), the threshold may be set to, for example, 100 meters or even 200 meters to prevent the virtual image from suddenly shifting away from the field of vision of the user.

In step 207, the processor 13 moves the position of the reference point to a reference position that is at most the threshold away from the user position in the real-world coordinate system (labelled as “A” in FIG. 3), and the flow proceeds to step 209. It should be noted that the reference position is on a straight line defined by the position of the reference point before being moved (i.e., before performing step 207) and the user position obtained in step 205. At this time, the position of the reference point is at the reference position.

It should be noted that the user coordinate system is not defined by an orientation of the computing device 1. Specifically, the processor 13 defines the user coordinate system by defining the user position obtained in step 205 as an origin of the user coordinate system, and defining a direction from the position of the reference point to the user position as a front direction in the user coordinate system. Therefore, the user coordinate system is constantly updated every time the reference position is updated (i.e., every time step 207 is performed). It should be noted that, a downward direction in the user coordinate system may be defined as a direction of the gravitational force of the Earth, and a right direction of the user coordinate system may be defined as a direction that is perpendicular to both of the front direction and the downward direction in the user coordinate system (as shown in FIG. 3).

In step 208, when the processor 13 determines that the distance is not greater than the threshold, the processor 13 maintains the position of the reference point, and thus the user coordinate system is not updated, and the flow goes back to step 204. That is to say, if the position of the reference point is originally at the temporary position in the real-world coordinate system, then the position of the reference point remains at the temporary position in the real-world coordinate system. If the position of the reference point is originally at the reference position in the real-world coordinate system, then the position of the reference point remains at the reference position in the real-world coordinate system.

In step 209, the processor 13 obtains a display position in the user coordinate system (labelled as “C” in FIG. 3) based on the position of the reference point, and controls the display 12 to display the virtual image at the display position, where a display orientation of the virtual image is controlled to be identical to a direction from the display position to the user position obtained in step 205 (i.e., the virtual images is controlled to be facing the user position obtained in step 205). Specifically, the display position is a position in the user coordinate system that is at a predetermined distance (e.g., 30 cm) from the user position in a predetermined direction (e.g., 10 degrees to the right and 5 cm downward), but the disclosure is not limited to such. The flow then goes back to step 204.

As the user moves, the computing device 1 repeatedly performs steps 204 to 209 so as to continue displaying the virtual image to the user with a good visual experience. It should be noted that, if the determination made in step 206 is negative (i.e., if the distance between the position of the reference point and the user position is not greater than the threshold), the user coordinate system will not be updated since the reference position has not been updated. As such, the virtual image will remain at the display position with the same display orientation, and the user may be able to view the virtual image from the sides.

In summary, the method according to the disclosure is capable to define the reference point by the processor 13, and keep the distance between the position of the reference point and the user position within the threshold. Moreover, the method is capable of displaying the virtual image at the relative position based on the position of the reference point (i.e., the display position) so that the virtual image may follow the user as the user moves, and may be displayed in a direction that does not deviate from a line of sight of the user even when the user turns his or her head. Furthermore, the processor 13 controls the display orientation of the virtual image so that the virtual image faces the user position that is obtained in step 205 and that is used for defining the reference position in step 207.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for displaying a virtual image to a user, the method implemented by a computing device and comprising:
obtaining an initial position of the user;
defining a reference point based on the initial position of the user;
obtaining a user position of the user;
determining whether a distance between a position of the reference point and the user position is greater than a threshold;
in response to determining that the distance is greater than the threshold, moving the position of the reference point to a reference position that is at most the threshold away from the user position; and
obtaining a display position as a relative position based on the position of the reference point, and displaying the virtual image at the display position.

2. The method as claimed in claim 1, wherein, in displaying the virtual image, a display orientation of the virtual image is controlled to be identical to a direction from the display position to the user position of the user.

3. The method as claimed in claim 1, further comprising, after determining whether the distance is greater than the threshold, in response to determining that the distance is not greater than the threshold, maintaining the position of the reference point.

4. The method as claimed in claim 1, wherein the reference position is on a straight line defined by the position of the reference point before being moved and the user position.

5. The method as claimed in claim 1, wherein the virtual image is a graphical user interface.

6. The method as claimed in claim 5, wherein the virtual image is displayed using a mobile augmented reality technology.

7. A computing device for displaying a virtual image to a user, comprising:
a positioning module configured to obtain a position of the user;
a display; and
a processor configured to
obtain an initial position of the user from said positioning module,
define a reference point based on the initial position of the user,
obtain a user position of the user from said positioning module,
determine whether a distance between a position of the reference point and the user position is greater than a threshold,
in response to determining that the distance is greater than the threshold, move the position of the reference point to a reference position that is at most the threshold away from the user position; and
obtain a display position as a relative position based on the position of the reference point, and control said display to display the virtual image at the display position.

8. The computing device as claimed in claim 7, wherein a display orientation of the virtual image is controlled by said processor to be identical to a direction from the display position to the user position of the user.

9. The computing device as claimed in claim 7, wherein said processor is further configured to, in response to determining that the distance is not greater than the threshold, maintain the position of the reference point.

10. The computing device as claimed in claim 7, wherein the reference position is on a straight line defined by the position of the reference point before being moved and the user position.

11. The computing device as claimed in claim 7, wherein the virtual image is a graphical user interface.

12. The computing device as claimed in claim 11, wherein the virtual image is displayed using a mobile augmented reality technology.
